(19) United States
(12) Patent Application Publication
(10) Pub. No.: US 2017/0193176 A1
(43) Pub. Date: Jul. 6, 2017

(54) System, Method, and Software for Improved Drug Efficacy and Safety in a Patient

(71) Applicant: Insilico Medicine, Inc., Baltimore, MD (US)

(72) Inventors: Nicolay Borisov, Krasnoznamensk (RU); Anton Buzdin, Istra (RU); Aleksandrs Zavoronkovs, London (GB); Alexander Aliper, Ramenskoye (RU); Daria Allina, Moscow (RU); Olga Kovalchuk, Baltimore, MD (US); Boris Zhestkov, Moscow (RU); Valery Shirokorad, Moscow (RU); Kirill Kashintsev, Moscow (RU); Stanislav Kostritsky, St. Petersburg (RU)

(21) Appl. No.: 15/392,517

(22) Filed: Dec. 28, 2016

Related U.S. Application Data
(60) Provisional application No. 62/272,702, filed on Dec. 30, 2015.

(51) Int. Cl. G06F 19/00; G06N 5/04

(52) U.S. Cl. CPC G06F 19/345; G06F 19/3456; G06F 19/322; G06N 5/04

(57) ABSTRACT

The present invention provides systems, methods and software for predicting drug efficacy for treating a disorder in a patient, the method including providing a drug scoring database based on pathway activation strengths (PASs) for a plurality of biological pathways associated with the drug in the treatment of the disorder, thereafter providing a support vector machines (SVM) to enable SVM tuning using a floating window to transfer data from a training dataset (T) to a validation dataset (V) by interpolation along at least one PAS axis and further determining if both i) there is a positive correlation coefficient between a drug score and a clinical efficacy of the drug and ii) an area-under a curve (AUC) statistical indicator for the drug score exceeds 0.7; to provide a predictive indication if the patient is a responder or non-responder to the drug to determine whether the drug should be used in treating the patient.

### FIELD OF THE INVENTION

The present invention relates generally to systems and methods of analysis of gene signaling pathways, and more specifically to systems and methods for improving efficacy and safety of drug combinations in a patient, based upon signalome data analysis.

### BACKGROUND OF THE INVENTION

In the twentieth century, enormous strides were made in combatting infectious diseases, in their detection and drugs to treat them. The major problem in the medical world has thus shifted from treating acute diseases to treating chronic diseases. Over the last few decades, with the advent of genetic engineering, much research and funding has been invested in genomics and gene-based personalized medicine. A need has arisen to develop diagnostic tools for use in the characterization of personalized aspects of chronic diseases and diseases associated with aging.

Novel methods have been developed for screening for drugs that can minimize the difference between the various cellular or tissue states in a variety of tissues, while also taking into accounting for toxicity and adverse effect of the drug.

Intracellular signaling pathways (SPs) regulate numerous processes involved in normal and pathological conditions including development, growth, aging and cancer. Many bioinformatic tools have been developed, which analyze SPs.

The information relating to signaling pathway activation (SPA) can be obtained from the massive proteomic or transcriptomic data. Although the proteomic level may be somewhat closer to the biological function of SPA, the transcriptomic level of studies today is far more feasible in terms of performing experimental tests and analyzing the data.

US2008254497A provides a method of determining whether tumor cells or tissue is responsive to treatment with an ErbB pathway-specific drug. In accordance with the invention, measurements are made on such cells or tissues to determine values for total ErbB receptors of one or more types, ErbB receptor dimers of one or more types and their phosphorylation states, and/or one or more ErbB signaling pathway effector proteins and their phosphorylation states. These quantities, or a response index based on them, are positively or negatively correlated with cell or tissue responsiveness to treatment with an ErbB pathway-specific drug. In one aspect, such correlations are determined from a model of the mechanism of action of an ErbB pathway-specific drug on an ErbB pathway. Preferably, methods of the invention are implemented by using sets of binding compounds having releasable molecular tags that are specific for multiple components of one or more complexes formed in ErbB pathway activation. After binding, molecular tags are released and separated from the assay mixture for analysis.

U.S. Pat. No. 8,623,592 discloses methods for treating patients which methods comprise methods for predicting responses of cells, such as tumor cells, to treatment with therapeutic agents. These methods involve measuring, in a sample of the cells, levels of one or more components of a cellular network and then computing a Network Activation State (NAS) or a Network Inhibition State (NIS) for the cells using a computational model of the cellular network. The response of the cells to treatment is then predicted based on the NAS or NIS value that has been computed. The invention also comprises predictive methods for cellular responsiveness in which computation of a NAS or NIS value for the cells (e.g., tumor cells) is combined with use of a statistical classification algorithm. Biomarkers for predicting responsiveness to treatment with a therapeutic agent that targets a component within the ErbB signaling pathway are also provided.

The computational methods for analysis of changes in signaling pathways at certain pathological conditions have been extensively developed during several last years (Bild et al., 2005)(Itadani et al., 2008)(Su et al., 2009)(Fertig et al., 2012)(Liu et al., 2012)(Khunlertgit and Yoon, 2013)(Afsari et al., 2014)(Korucuoglu et al., 2014). Although most these methods rely on the results of transcriptome profiling, there are some that involve proteomic and genomic data.

Within this stream of efforts, lies our bioinformatics software OncoFinder (Zhavoronkov et al., 2014)(Buzdin et al., 2014)(Spirin et al., 2014)(Borisov et al., 2014)(Lezhnina et al., 2014) that accumulates the data of transcriptome profiling into the weighted sum of log-fold-changes between the case and control, arriving at the following estimator for signaling pathway perturbations, termed pathway activation score (PAS),

$${PAS}_{p} = {\sum }_{n} {ARR}_{np} \cdot {BTIF}_{n} \cdot log ( {CNR}_{n} ) .$$

Here CNRn is the case-to-normal ratio, which is equal to ratio of expression levels for a gene n in a given patient and the average normal level in the population,

$${BTIF}_{n} = \{ \begin{matrix}0 , {CNR}_{n} value lies within the tolerance interval \\ 1 , {CNR}_{n} value lies beoynd the tolerance interval\end{matrix}$$

ARR is an activator/repressor role discrete flag:

$${ARR}_{np} = \{ \begin{matrix}- 1 ; gene p roduct ( protein ) n is a \\ signal repressor in a pathway p \\ - 0 , 5 ; gene product n is more likely \\ s signal repressor in a pathway p \\ 0 ; the role of a gene product n in a \\ pathway p is either ambivalent or netral \\ 0 , 5 ; gene product n is more likely a \\ signal activator in a pathway p \\ 1 ; gene product n is a signal \\ acivator in a pathway p\end{matrix} .$$

The applicability of the suggested measure PAS for the pathological changes in signaling pathways was tested using the “low-level” kinetic models of protein-protein interactions that have been fitted using the Western blotting data (Kuzmina and Borisov, 2011).

There thus remains a need for systems and methods, which can predict drug efficacy of drug combinations in a patient. There further remains a need for systems and methods, which can predict drug combination adverse effects. There also remains a need for systems and methods, which can predict and maximize drug combination positive pathway activation.

### SUMMARY OF THE INVENTION

It is an object of some aspects of the present invention to provide systems and methods, for improving efficacy and safety of drug combinations in a patient.

There is thus provided according to an embodiment of the present invention, a method for improving drug efficacy and safety for treating a disorder in a patient, the method comprising:
a. providing a method to enable support vector machine (SVM) tuning using a floating window to transfer data from a training dataset (T) to a validation dataset (V) by interpolation along at least one PAS axis;
b. determining if both
   i. there is a positive correlation coefficient between a drug score and a clinical efficacy of the drug; and
   ii. an area-under a curve (AUC) statistical indicator for the drug score exceeds 0.7; to provide a predictive indication if the patient is a responder or non-responder to the drug to determine whether the drug should be used in treating the patient.

Additionally, according to an embodiment of the present invention, the drug is a kinase inhibitor.

Further, according to an embodiment of the present invention, the kinase inhibitor is selected from Pazopanib, Sorafenib and Sunitinib.

Furthermore, according to an embodiment of the present invention, only i_prox proximal points in the T-dataset in the phase space with the reduced dimensionality are applied when evaluating the drug score for a point of the V-dataset.

Additionally, according to an embodiment of the present invention, the method further comprises iii) obtaining a best threshold (τ) value to separate responders from non-responders to a specific drug; and iv) co-normalizing a patient's X data and the V data using a Bolstad quantile normalization method.

Moreover, according to an embodiment of the present invention, the method further comprises defining quasi clinical efficacies for a plurality of the drugs in a plurality of cell lines.

Additionally, the present invention provides a computer software product, the product configured for predicting drug efficacy for treating a disorder in a patient, the product comprising a computer-readable medium in which program instructions are stored, which instructions, when read by a computer, cause the computer to:
a. provide a drug score database (DSD) based on pathway activation strengths (PASs) for a plurality of biological pathways associated with the drug in the treatment of the disorder;
b. provide a method for support vector machine (SVM) tuning using a floating window to transfer data from a training dataset (T) to a validation dataset (V) by interpolation along at least one PAS axis;
c. determine if both:
   i. there is a positive correlation coefficient between a drug score and a clinical efficacy of said drug; and
   ii. an area-under a curve (AUC) statistical indicator for the drug score exceeds 0.7; to provide a predictive indication if said patient is a responder or non-responder to said drug to determine whether said drug should be used in treating said patient.

The present invention further provides a system for predicting drug efficacy for treating a disorder in a patient the system comprising:
a. a processor adapted to activate a computer-readable medium in which program instructions are stored, which instructions, when read by a computer, cause the processor to:
   i. provide a method for support vector machine (SVM) tuning using a floating window to transfer data from a training dataset (T) to a validation dataset (V) by interpolation along at least one PAS axis;
   ii. determine if both
      i. there is a positive correlation coefficient between a drug score and a clinical efficacy of said drug; and
      ii. an area-under a curve (AUC) statistical indicator for the drug score exceeds 0.7; to provide a predictive indication if said patient is a responder or non-responder to said drug to determine whether said drug should be used in treating said patient;
b. a memory for storing said drug score database (DSD); and
c. a display for displaying data associated with said predictive indication of said patient.

The present invention will be more fully understood from the following detailed description of the preferred embodiments thereof, taken together with the drawings.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A is a simplified schematic illustration of a system for improving efficacy and safety of drug or drug combinations in a patient, in accordance with an embodiment of the present invention;

FIG. 1B is a schematic showing further details of drug profile database and transcriptomic database of FIG. 1A, in accordance with an embodiment of the present invention; and

FIGS. 2A-2D are simplified schematic steps in a method for improving efficacy and safety of a drug or drug combination in a patient, in accordance with an embodiment of the present invention;

FIGS. 3A-3B are simplified diagrams of effects of a drug on up-regulating and down-regulating signaling and metabolic pathways, respectively, in accordance with embodiments of the present invention;

FIG. 4 is a simplified illustration of a training data set and a validation data set in two-dimensional space, in accordance with an embodiment of the present invention; and

FIG. 5 is a simplified diagram of a classification of response to Sorafenib for a patient according to a FloWPS scale with a polynomial SVM kernel and averaged normalization of a T-dataset, in accordance with embodiments of the present invention.

In all the figures similar reference numerals identify similar parts.

### DETAILED DESCRIPTION OF PREFERRED EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

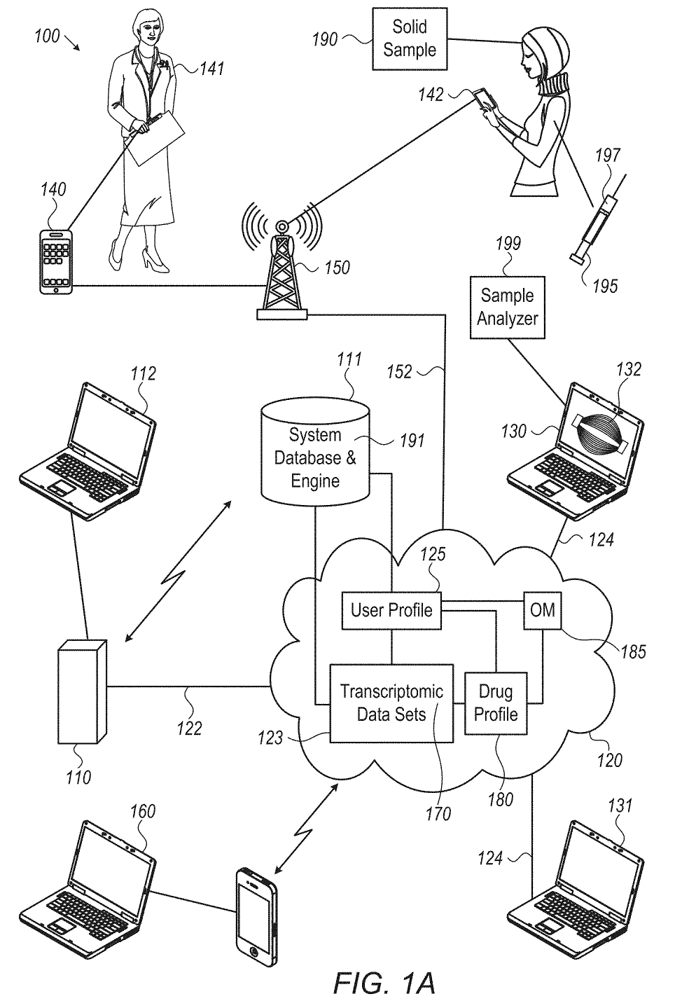

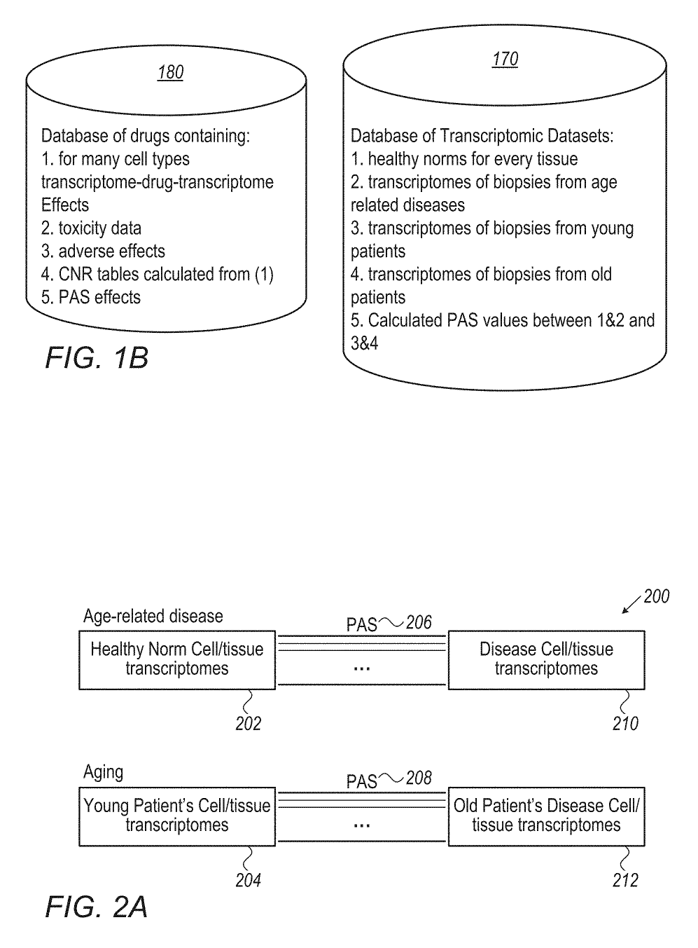

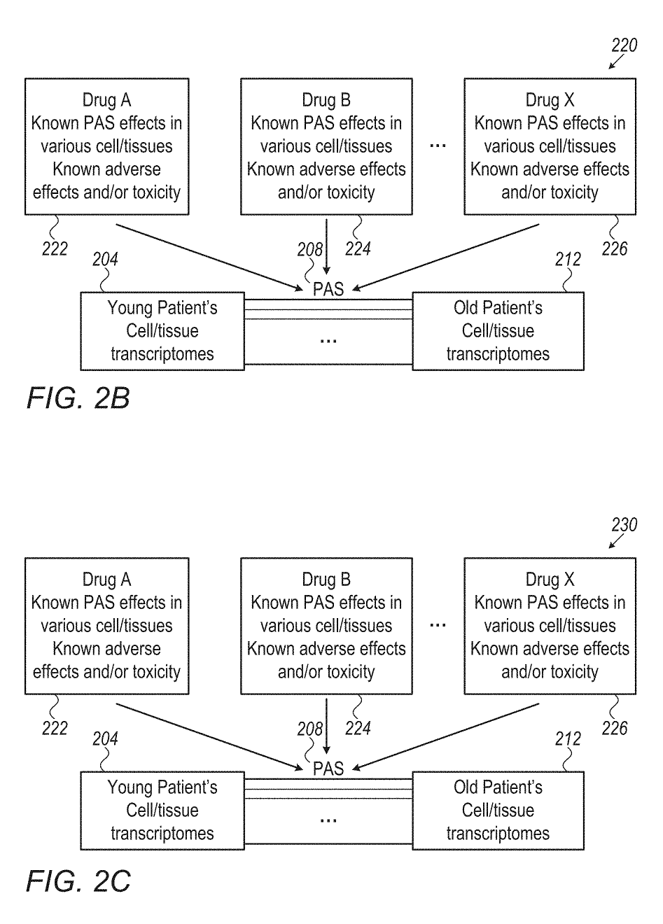

Reference is now made to FIG. 1A, which is a simplified schematic illustration of a system for improving efficacy and safety of drug combinations in a patient, in accordance with an embodiment of the present invention.

System 100 typically includes a server utility 110, which may include one or a plurality of servers and one or more control computer terminals 112 for programming, trouble-shooting servicing and other functions. Server utility 110 includes a system engine 111 and database, 191. Database 191 comprises a user profile database 125, a pathway cloud database 123 and a drug profile database 180.

Depending on the capabilities of a mobile device, system 100 may also be incorporated on a mobile device that synchronizes data with a cloud-based platform.

The drug profile database comprises data relating to a large number of drugs for controlling and treating ageing processes. For each type of drug, the dosage values, pharmo-kinetic data and profile, pharmodynamic data and profiles are included.

The drug profile database further comprises data of drug combinations, including dosage values pharmo-kinetic data and profile, pharmodynamic data and profiles.

A medical professional, research personnel or patient assistant/helper/carer 141 is connected via his/her mobile device 140 to server utility 110. The patient, subject or child 143 is also connected via his/her mobile device 142 to server utility 110. In some cases, the subject may be a mammalian subject, such as a mouse, rat, hamster, monkey, cat or dog, used in research and development. In other cases, the subject may be a vertebrate subject, such as a frog, fish or lizard. The patient or child's is monitored using a sample analyzer 199. Sample analyzer 199, may be associated with one or more computers 130 and with server utility 110. Computer 130 and/or sample analyzer 199 may have software therein for predicting drug efficacy in a patient, as will be described in further details hereinbelow.

Typically, gene expression data 123 (FIG. 1), generated by the software of the present invention, is stored locally and/or in cloud 120 and/or on server 110.

The sample analyzer may be constructed and configured to receive a solid sample 190, such as a biopsy, a hair sample or other solid sample from patient 143, and/or a liquid sample 195, such as, but not limited to, urine, blood or saliva sample. The sample may be extracted by any suitable means, such as by a syringe 197.

The patient, subject or child 143 may be provided with a drug (not shown) by health professional/research/doctor 141.

System 100 further comprises an outputting module 185 for outputting data from the database via tweets, emails, voicemails and computer-generated spoken messages to the user, carers or doctors, via the Internet 120 (constituting a computer network), SMS, Instant Messaging, Fax through link 122.

Users, patients, health care professionals or customers 141, 143 may communicate with server 110 through a plurality of user computers 130, 131, or user devices 140, 142, which may be mainframe computers with terminals that permit individual to access a network, personal computers, portable computers, small hand-held computers and other, that are linked to the Internet 120 through a plurality of links 124. The Internet link of each of computers 130, 131, may be direct through a landline or a wireless line, or may be indirect, for example through an intranet that is linked through an appropriate server to the Internet. System 100 may also operate through communication protocols between computers over the Internet which technique is known to a person versed in the art and will not be elaborated herein.

Users may also communicate with the system through portable communication devices such as mobile phones 140, communicating with the Internet through a corresponding communication system (e.g. cellular system) 150 connectable to the Internet through link 152. As will readily be appreciated, this is a very simplified description, although the details should be clear to the artisan. Also, it should be noted that the invention is not limited to the user-associated communication devices—computers and portable and mobile communication devices—and a variety of others such as an interactive television system may also be used.

The system 100 also typically includes at least one call and/or user support and/or tele-health center 160. The service center typically provides both on-line and off-line services to users. The server system 110 is configured according to the invention to carry out the methods of the present invention described herein.

It should be understood that many variations to system 100 are envisaged, and this embodiment should not be construed as limiting. For example, a facsimile system or a phone device (wired telephone or mobile phone) may be designed to be connectable to a computer network (e.g. the Internet). Interactive televisions may be used for inputting and receiving data from the Internet. Future devices for communications via new communication networks are also deemed to be part of system 100. Memories may be on a physical server and/or in a virtual cloud.

A mobile computing device may also embody a non-synced or offline copy of memories, copies of pathway cloud data, user profiles database, drug profiles database and execute the system, engine locally.

1. Drug Scoring for their Ability to Compensate the Pathological Changes in the Signaling Pathways

The following method has been proposed for predictive assessment of drug efficiency for individual patients based on their ability to compensate the pathological changes in the plethora of signaling pathways (signalome). For example, for the inhibitor drugs the following scheme was proposed.

$$DS {1}_{d} = {\sum }_{t} {DTI}_{dt} {\sum }_{p} {NII}_{tp} \cdot {AMCF}_{p} \cdot {PAS}_{p} ,$$

where the pathway activation strength, PAS, is

$${PAS}_{p} = {\sum }_{n} {ARR}_{np} \cdot {BTIF}_{n} \cdot 1 g ( {CNR}_{n} ) .$$

Here CNRₙ is the case-to-normal ratio, which is equal to ratio of expression levels for a gene n in a given patient and the average normal level in the population,

$${BTIF}_{n} = \{ \begin{matrix}0 , {CNR}_{n} value lies within the tolerance interval \\ 1 , {CNR}_{n} value lies beoynd the tolerance interval\end{matrix}$$

ARR is a activator/repressor role discrete flag:

$${ARR}_{np} = \{ \begin{matrix}- 1 ; protein n is a \\ signal repressor in a pathway p \\ - 0 , 5 ; protein n is more likely \\ s signal repressor in a pathway p \\ 0 ; the role of a protein n in a \\ pathway p is either ambivalent or netral \\ 0 , 5 ; protein n is more likely a \\ signal activator in a pathway p \\ 1 ; protein n is a signal \\ acivator in a pathway p\end{matrix} .$$

AMCF (activation-to-mitosis conversion factor) is a discrete flag

$${AMCF}_{p} = \{ \begin{matrix}- 1 , pathway activation is anti \text{-} mitotic \\ 1 , pathwasy activation is pro \text{-} mitotc\end{matrix}$$

The action of a (protein activity inhibitor) drug was described using the discrete drug-target index:

$${DTI}_{dt} = \{ \begin{matrix}0 , drug d inhibits protein t \\ 1 , drug d does not inhibit protein t\end{matrix}$$

The discrete flag of node involvement index is

$${NII}_{tp} = \{ \begin{matrix}0 , pathway p does not contain th e protein t \\ 1 , pathaway p contains the protein t\end{matrix}$$

For the activator drugs the DS1 function should be used with the opposite (“minus”) sign before the right-hand part.

Although this approach was previously proposed for the targeted drugs in oncology: monoclonal antibodies (a.k.a. mabs), kinase inhibitors (a.k.a. nibs) etc., it can be extended to other fields of medicine, such as, e.g., geriatrics and used for scoring of geroprotectors according to their ability to restore the juvenile state of signaling pathways in the critical (bone marrow, epithelial, osteoblast etc.) cells of a given aged person.

2. Possible Modifications of the Formula for Drug Scoring

1. A Priori and a Posteriori Drug Scores

Thus, the vectors of PAS for each disease case constitute the distinct signature of the whole set of signaling pathways (siganlome). Such signatures, both at the level of distinct genes and whole pathways, have been vividly used for recognition of nosologic types of various diseases. This recognition generally uses the procedure of machine learning on previous experience. Yet another challenge arises from the studies of signalomic signatures. Perhaps the more demanded and still unsolved until the recent times problem deals with drug scoring, i.e. detecting the indications for certain drug prescription for the personal case, whose transcriptome, and, consequently, signalome, is investigated.

Two principal approaches can be suggested for the procedure of drug scoring. The first type of drug scores, say a priori scores, uses the abilities of a certain drug to restore the normal status of the signalome, or to terminate the physiological process that is considered pathogenic for a certain disease (e.g. cell proliferation for cancer etc.). These drug scores (termed drug scores 1-2, DS1-DS2, in unpublished US provisional patent applications) have been disclosed previously. The unpublished US provisional patent applications have also disclosed anther type of drug score, drug score 3 (DS3), which is an a posteriori drug score, that is result of a machine learning process on a training dataset (T), which contains PAS vectors in the multi-dimensional signalome phase space from many clinical cases of application of the certain treatment method, together with the known clinical outcome of this method (whither this certain patient was a responder or not on the method). For the training dataset, any machine-learning scheme attempts to distinguish between the responder and non-responder clusters in the milti-dimensional phase space (in our case of signalome investigation, this is the phase space of PAS for different pathways).

2. Support Vector Machines and Selection of Training Datasets for them

Support vector machines (SVM) are among the most advanced and powerful tools for such machine-learning-based classification and regression analysis (Osuna et al., 1997)(Bartlett and Shawe-Taylor, 1999)(Vapnik and Chapelle, 2000)(Robin et al., 2009). The core idea of SVM as a separation tool between clusters of points in the multi-dimensional space relies on maximization of the margin between these clusters that is determined by the separation hypersurface (it can be planar or curved according to various mathematical kernel, by the choice of the user). In comparison with other algorithms for machine-learning, e.g., classical multi-layer perceptrons (MLP) that use the least square fitting procedure for training data (Minsky and Papert, 1987), SVMs have proved to be more robust in terms of the changes in input data and, therefore, less demanding for the huge number of vectors in the training dataset (Osuna et al., 1997, (Bartlett and Shawe-Taylor, 1999, Vapnik and Chapelle, 2000, and Robin et al., 2009).

The latter circumstance is very important for our case of drug scoring for cancer patients, since typically classical MLPs require tens of thousands points for the training dataset to provide the adequate coverage of the phase space (Sboev, 2014—a condition that lies far beyond of the current capacity of annotated transcriptomes for the cancer patients with the case histories that specify both treatment method and the clinical response). Contrary, SVM separators may adequately work with many fewer points (about one or several hundreds) in the T-dataset (Sboev, 2014), which (a condition which may be satisfied much easily).

However, for most anti-cancer drugs it is still extremely difficult (if ever possible) to find hundreds of annotated transcriptomes that were obtained using the same investigation platform for the patients that were treated with the dame drug with the known clinical outcome of the treatment. However, providing such coverage in the phase space of PAS is a necessary condition for adequate performance of the SVM.

Therefore, an alternative method is proposed for constructing an SVM model that uses the datasets obtained on large numbers of cell lines which were treated with various anti-cancer drugs, e.g. kinase inhibitors (nibs).

3. Transition of the SVM Models from the Training (T-) to Validation (V-) Datasets: SVM Tuning Using “Floating Window”

The most complicated operation in construction of machine-learning drug scores is the transfer of data form the training (T-) dataset to the validation (V-) one. Contrary to many situations where the SVMs are applied, such as friend-or-foe recognition in radar signal processing or bank credit scoring, during the PAS-based drug scoring the range and span of the area in the phase space for the T- and V-dataset are not a priori known, and in most cases, the areas in the phase space where the T- and V-datasets exist, do not overlap. That is why without the additional tuning the PAS-based SVM models for drug scoring are doomed to extrapolate rather than interpolate in the multi-dimensional phase-apace, that is very vulnerable to producing the incorrect, if not meaningless, results.

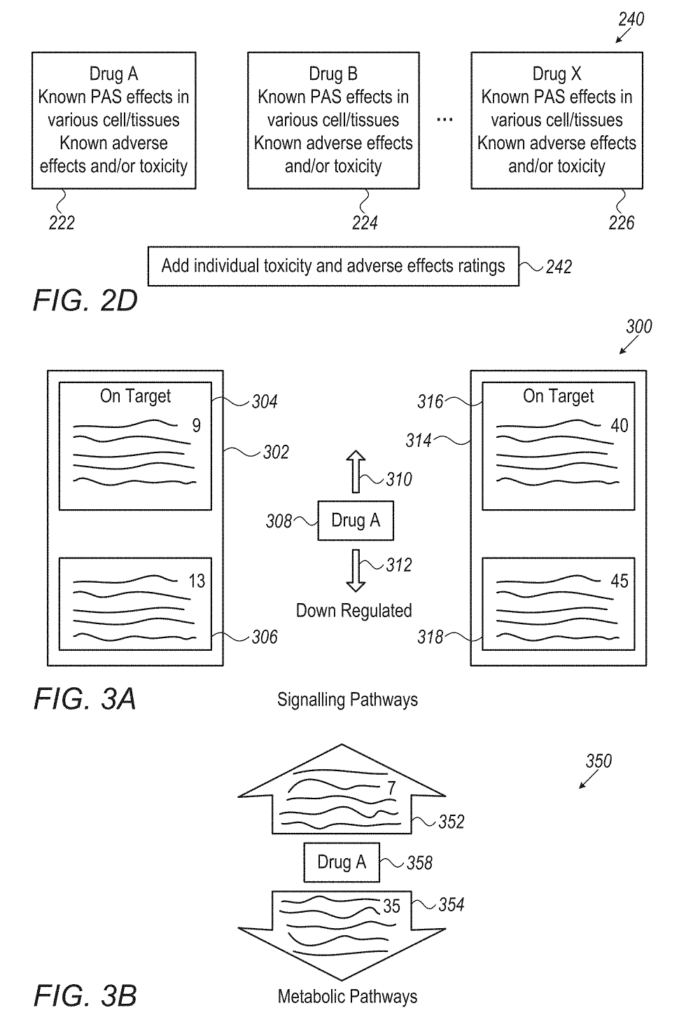

FIG. 4 illustrates this problem using the simplified example of two-dimensional PAS space. Let the pathway P1 have the value of PAS1 after the activation scoring, whereas the pathway P2 has the activation strength of PAS2. As far as indicated in the figure, the PAS1 values for the training (T-) and validation (V-) datasets overlap between each other, whilst the PAS2 values for the T- and V-datasets do not. That is why the dimension of PAS1 is suitable for the construction of the SVM-based separator in the phase space of PASes of different pathways, and the dimension of PAS2 is not.

To prevent the SVM-method from meaningless extrapolation, the FLOating Window Projective Separator (FoWPS) method, which uses a “floating window” method is proposed for the SVM tuning.

According to “floating window” method, we should observe the following conditions when the transferring the data from T- to V-dataset, taling in fact a “projection” of the whole phase space to the reduced space that provides interpolation over all its dimensions
1) First, one should only interpolate rather than extrapolate along each axis (which corresponds to the PAS values of a certain pathway) of the phase space when building a mathematical model that separates responders from non-responders. The minimal number of points in a T-dataset that should be both to the left-hand and the right-hand side from each point of a V-dataset, is denoted as i_inside in our method. If a certain PAS dimension does not satisfy this criterion, then this dimension in the phase space should not be taken into account, and the whole phase space should be reduced using a rectangular geometric projection through this dimension.
2) Second, one should take into account only i_prox proximal points in the T-dataset in the phase space with the reduced dimensionality when evaluating the drug score for a point of the V-dataset.

The two parameters (i_inside, i_prox) that define the “floating window” should be adjusted for each combination of the T- and V-dataset to provide the successful drug score for the V-dataset. The practice shows the trend that the more “populous” is the V-dataset, the wider should be the “floating window”.

The problem of extrapolation as an Achilles heel of the SMS have been recognized previously in other fields of research rather than bioinformatics and transcriptomics, such as quantum chemistry (Arimoto et al., 2005)(Balabin and Lomakina, 2011), analytical chemistry and material science (Balabin and Smirnov, 2012) or environmental engineering (Betrie et al., 2013), although we did not encounter in the literature the explicitly formulated “floating window” method of SVM tuning aimed to exclude the extrapolation in the phase space.

We have shown that at least for three human normal cell cultures that were uses for the normalization of the CancerRxGene cell line T-dataset (aortic smooth muscle cells, cells from liver non-tumor tissue of a liver cancer patient, and a non-tumor gliotic brain tissue), as well as for the normalization averaged over these three normalizations mentioned above, for two geometric kernels of the SVM model (planar and polynomial cubic spline) and three targeted drugs (pazopanib, sorafenib and sunitinib) that were applied to treat the renal cancer patients (used as the V-dataset), there exist at last some values in parameter space of (i_inside, i_prox) that provide the successful SVM-based drug score. The criterion for the drug score success was that the correlation coefficient between the drug score and clinical efficiency of the drug should be positive, and, simultaneously, the area-under curve (AUC) statistical indicator (Green et al., 1966) for the drug score AUC exceeds 0.7).

4. Algorithm for Drug Scoring of the Transcriptome of an Patient (X) with Unknown Drug Efficiency Prognosis

Thus, we are able now to formulate the algorithm for drug scoring of the transcriptome of a patient (X) with unknown drug efficiency prognosis. The following finding is rather important and seems to be absent in the literature. Additionally to what is written in numerous textbooks, our drug score seems to operate with three rather than two, layers of data. Whereas the textbooks say about T- and V-datasets, we have encountered that we should distinguish three rather than two types of data.
1) First, it is the T-dataset, whose points and vectors are used to build a mathematical model that separates responders from non-responders. The principal requirement for this dataset to be rather abundant to provide the maximal coverage for the PAS phase space.
2) Second, there is the V-dataset that is used for the adjustment of “floating window” parameters. The V-dataset should contain a few cases with the known result of application of a certain drug for a certain disease. The more numerous are the clinical cases in the V-dataset, the more reliable is the drug score; however, the V-dataset does not need to be as “populous” as the T-dataset, since it used only for the specification of “floating window” discrimination threshold (τ) in the drug score scale that separates “responder” cases from “non-responder”. The parameters of a “floating window” (i_inside, i_prox) should be tuned before the investigation of X-data, to provide the maximal accuracy for the drug scoring that uses the transition from T- to V-dataset. After finding the optimal (i_inside, i_prox) parameters, the best value of the threshold τ should be defined to provide the maximal accuracy when separating responder cases from non-responder.
3) Third data (called, e.g., the X-data), i.e. the very patient that we should make a prognosis, whether a certain drug is suitable for him/her. To provide the maximal uniformity, the V- and X-data should be obtained same investigation platform using the co-normalized using the Bolstad quantile normalization method (Bolstad et al., 2003).

Supplementary Data: Materials and Methods

Selection and Preparation the Data for the T-Dataset

In our work, we have selected 227 cell lines that were treated with 22 different nibs. All the cell lines were examined before treatment using the Affymetrix microarray RNA hybridization platform according the P-MTAB-22737/22738 protocol. For every drug and every cell line, the cell growth half-inhibiting concentration (IC₅₀) was measured. The results of transcriptome investigations for these 227 cell lines, as well as the IC₅₀ values, were taken by us from the public repository CancerRxGene (CancerRxGene).

We normalized the gene expression data for these 227 cells on the following cell cultures taken from morphologically normal tissues that were also investigated using the Affymetrix microarray RNA hybridization machine.

TABLE 1
Data sets according to tissue type

| Tissue type | GEO datasets |
|---|---|
| Aortic smooth muscle | GSM530379, GSM530381 |
| Liver nun-tumor tissue | GSM370578, GSM370579, GSM370580, |
| of a liver cancer patient | GSM370581 |
| Non-tumor gliotic brain | GSM362995, GSM362996, GSM362997, |
| tissue | GSM362998, GSM362999, |
| | GSM363000, GSM363001, GSM363002, |
| | GSM363003, GSM363004 |

For these three types of normalizations, the values of PAS were calculated for 273 signaling pathways and 227 cell lines. The fourth “normalization”, termed “averaged”, was obtained by averaging of PAS that were calculated according to the three normalizations mentioned above.

The quasi-“clinical efficiencies” for 22 nibs and 227 cell lines were quantified according to the descending sorting of IC₅₀ values, as follows in Table 2

TABLE 2
Quasi-clinical efficiencies according to descending IC₅₀ quintiles

| | Quasi-“clinical efficiency” |
|---|---|
| 1^{st} quintile (20%) by | 0 |
| IC₅₀ | |
| 2^{nd} quintile (20%) by | 25 |
| IC₅₀ | |
| 3^{rd} quintile (20%) by | 50 |
| IC₅₀ | |
| 4^{th} quintile (20%) by | 75 |
| IC₅₀ | |
| 5^{th} quintile (20%) by | 100 |
| IC₅₀ | |

Selection and Preparation the Data for the V-Dataset

A set of samples taken from the tumors of renal cancer patients who were treated at Clinical Hospital of the Hertzen Cancer Institute in Moscow. These samples were examined using the Illumina HT-12 platform at Medical Center of Lethbridge University in Canada. As a reference normal renal tissue, the dataset GSE49972 (Karlsson et al., 2014) obtained on the same platform, was used. To constitute the V-dataset, only samples taken from the patients who were treated using the targeted drugs (nibs), such as pazopanib (Votrient), sorafenib (Nexavar) and suntinib (Sutent) with the certain clinical outcome, which indicates either sustained stabilization of tumor progress or the immediate failure of drug action (tumor progression despite the applied treatment), were selected. The overview of renal cancer transcriptomes selected for the V-dataset, is shown below in Table 3.

TABLE 3
Total Number of transcriptomes versus those from responders
and non-responders for three drugs

| | | | # of |
|---|---|---|---|
| | | # of | transcriptomes |
| | # of | transcriptomes taken | taken from |
| Drug | transcriptomes | from responders | non-responders |
| Pazopanib | 7 | 4 | 3 |
| Sorafenib | 28 | 13 | 15 |
| Sunitinub | 15 | 5 | 10 |

As an example, we list here the details of case history for one of the patient, who has been a responder to Sunitinib treatment.

Male, 65 years; the clear cell cancer in left kidney; disease progression stage T3N0M1, distant metastases to lungs and skeleton. Surgery has not been performed due to the overall progression of the disease. Before the chemotherapy for distant metastases, the patient received the symptomatic radiation therapy of 30 Gy on the pelvic and femoral zone. Two months after the patient received the neo-adjuvant Sunitinib therapy in overall dose of 50 mg. As a result of this drug therapy, positive changes have been recorded, considering the metastases in lungs, pelvic bones, as well as in the primary tumor area.

As long as two years after the treatment, the patient was still alive and continued to receive the adjuvant Sunitinib therapy.

Drug Scoring According the SVM Method with “Floating Window”

All calculations were done using the R statistical software. The SVM models, both planar (linear) and cubic spline polynomial, were constructed in the phase space of PAS of signaling pathways that contained gene products, which are listed as specific molecular targets of pazopanib, sorafenib and sunitinib, respectively.

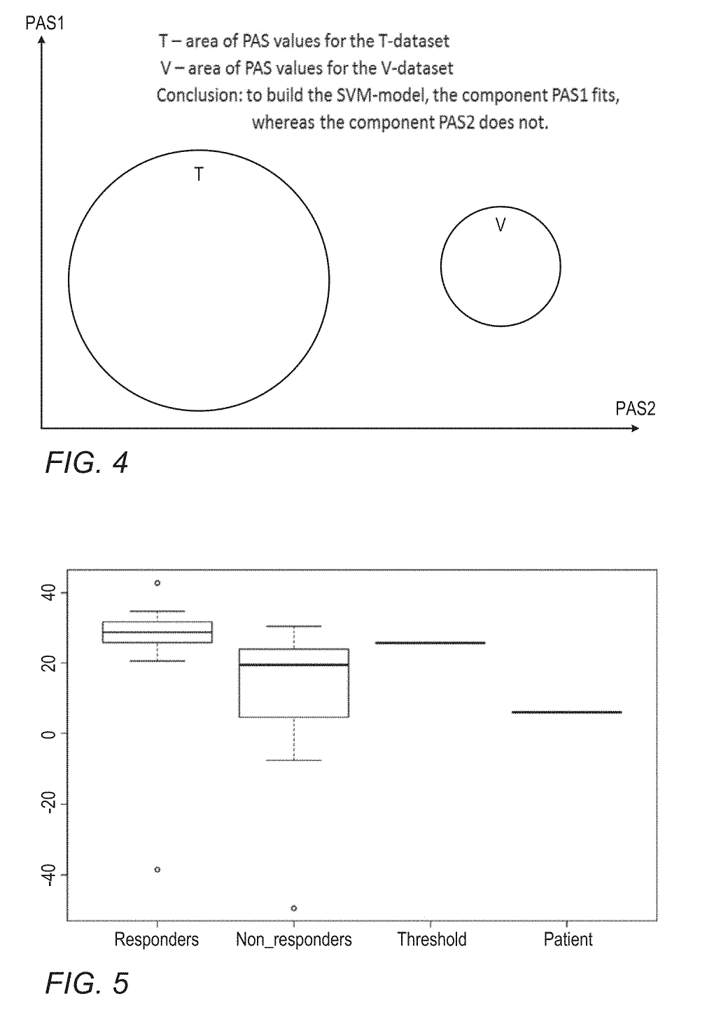

FIG. 5—classification of response to sorafenib for patient X according to the FloWPS scale with the polynomial SVM kernel and averaged normalization of the T-dataset. The boxplot shows the distribution of the FloWPS-based drug scores for the responder and non-responder samples in the V-dataset (renal cancer). The optimal threshold (τ) between the responders and non-responders is compared with the drug score for the patient under investigation (X).

The values of the AUC for the FloWPS-based drug score are listed in Table 4 and 5.

TABLE 4
AUC for FloWPS with planar (linear) kernel

T-dataset normalization

| Drug | Aortic | Glial | Liver | Averaged |
|---|---|---|---|---|
| Pazopanib | 1 | 1 | 0.83 | 1 |
| Sorafenib | 0.82 | 0.89 | 0.78 | 0.80 |
| Sunitinib | 0.94 | 0.94 | 0.84 | 0.86 |

TABLE 5
AUC for FloWPS with cubic spline (polynomial) kernel

T-dataset normalization

| Drug | Aortic | Glial | Liver | Averaged |
|---|---|---|---|---|
| Pazopanib | 1 | 1 | 1 | 1 |
| Sorafenib | 0.78 | 0.78 | 0.86 | 0.84 |
| Sunitinib | 1 | 1 | 0.96 | 0.94 |

Since for each drug tested model we have four T-dataset normalizations and two SVM kernels, this produces eight drug scoring scales for each drug, each with its own values of i_inside, i_prox and τ. The classification of the response to sorafenib for a patient X according to the scale with polynomial SVM-kernel and averaged normalization of the T-dataset is illustrated in FIG. 4.

FIG. 4 is a simplified illustration of a training data set and a validation data set in two-dimensional space, in accordance with an embodiment of the present invention.

The overall answer of the FloWPS predictor of response/non-response is formed as a result a “majority poll” between the eight classifiers according to eight drug scoring test (if the poll divides equally, the patient X is considered non-responder)—see Table 6 for a patient X.

TABLE 6
Classification of patient X as a responder/non-responder to
pazopanib, sorafenib and sunitinib

| | | | | Overall |
|---|---|---|---|---|
| Drug | Kernel | Normalization | Classified as | prognosis |
| Pazopanib | linear | aortic | Responder | Responder |
| Pazopanib | linear | glial | Non- | |
| | | | responder | |
| Pazopanib | linear | liver | Responder | |
| Pazopanib | linear | averaged | Responder | |
| Pazopanib | polynomial | aortic | Responder | |
| Pazopanib | polynomial | glial | Responder | |
| Pazopanib | polynomial | liver | Responder | |
| Pazopanib | polynomial | averaged | Responder | |
| Sorafenib | linear | aortic | Responder | Non-responder |
| Sorafenib | linear | glial | Non- | |
| | | | responder | |
| Sorafenib | linear | liver | Non- | |
| | | | responder | |
| Sorafenib | linear | averaged | Non- | |
| | | | responder | |
| Sorafenib | polynomial | aortic | Non- | |
| | | | responder | |
| Sorafenib | polynomial | glial | Responder | |
| Sorafenib | polynomial | liver | Non- | |
| | | | responder | |
| Sorafenib | polynomial | averaged | Non- | |
| | | | responder | |
| Sunitinib | linear | aortic | Responder | Responder |
| Sunitinib | linear | glial | Non- | |
| | | | responder | |
| Sunitinib | linear | liver | Responder | |
| Sunitinib | linear | averaged | Responder | |
| Sunitinib | polynomial | aortic | Responder | |
| Sunitinib | polynomial | glial | Responder | |
| Sunitinib | polynomial | liver | Responder | |
| Sunitinib | polynomial | averaged | Non- | |
| | | | responder | |

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

1-32. (canceled)

33. A method for improving drug efficacy and safety for treating a disorder in a patient, the method comprising:
a. providing a method for support vector machine (SVM) tuning using a floating window to transfer data from a training dataset (T) to a validation dataset (V) by interpolation along at least one PAS axis;
b. determining if both
i. i) there is a positive correlation coefficient between a drug score and a clinical efficacy of said drug; and
ii. ii) an area-under a curve (AUC) statistical indicator for the drug score exceeds 0.7; to provide a predictive indication if said patient is a responder or non-responder to said drug to determine whether said drug should be used in treating said patient.

34. A method according to claim 33, wherein said providing a drug score database (DSD) step comprises:
c. obtaining proliferative bodily samples and healthy bodily samples from patients;
d. applying said drug to said patients; and
e. determining responder and non-responder patients to said drug.

35. A method according to claim 34, wherein said determining step comprises comparing gene expression in selected signaling pathways.

36. A method according to claim 35, wherein said selected signaling pathways are associated with said drug.

37. A method according to claim 34, wherein said determining step further comprises determining a drug score at least one pathway activation strength (PAS) value for each pathway in said responder and said non-responder patients.

38. A method according to claim 37, wherein said determining step further comprises determining a drug score for said drug based on said at least one pathway activation strength (PAS) value.

39. A method according to claim 34, wherein said bodily samples are selected from the group consisting of a tissue sample, a cell culture, an individual single cell, a bodily sample, an organism sample and a microorganism sample.

40. A method according to claim 33, wherein said biological pathways are signaling pathways.

41. A method according to claim 33, wherein said biological pathways are metabolic pathways.

42. A method according to claim 35, wherein said gene expression comprises quantifying expression of plurality of gene products.

43. A method according to claim 42, further comprising:
f. calculating a pathway activation strength (PAS), indicative of said pathway activation of each of said biological pathways.

44. A method according to claim 43, wherein said calculating step comprises adding concentrations of said set of said at least five gene products of said sample and comparing to a same set in said at least one control sample.

45. A method according to claim 44, wherein said at least one function comprises an activation function and a suppressor function.

46. A method according to claim 45, wherein said at least one function comprises an up-regulating function and a down-regulating function.

47. A method according to claim 34, wherein said determining step comprises at least one of profiling gene expression, RNA profiling, RNA sequencing, DNA profiling, DNA sequencing, protein profiling, amino acid sequencing, at least one immunochemical methodology, a mass spectrometry analysis, a microarray technology, a quantitative PCR methodology and combinations thereof.

48. A method according to claim 33, wherein said drug is a kinase inhibitor.

49. A method according to claim 48, wherein said kinase inhibitor is selected from pazopanib, sorafenib and sunitinib.

50. A computer software product, said product configured for predicting drug efficacy for treating a disorder in a patient, the product comprising a computer-readable medium in which program instructions are stored, which instructions, when read by a computer, cause the computer to:
a. provide a drug score database (DSD) based on pathway activation strengths (PASs) for a plurality of biological pathways associated with the drug in the treatment of the disorder;
b. provide a support vector machines (SVM) to enable SVM tuning using a floating window to transfer data from a training dataset (T) to a validation dataset (V) by interpolation along at least one PAS axis;
c. determine if both:
i. there is a positive correlation coefficient between a drug score and a clinical efficacy of said drug; and
iii. an area-under a curve (AUC) statistical indicator for the drug score exceeds 0.7; to provide a predictive indication if said patient is a responder or non-responder to said drug to determine whether said drug should be used in treating said patient.

51. A system for predicting drug efficacy for treating a disorder in a patient the system comprising:
a. a processor adapted to activate a computer-readable medium in which program instructions are stored, which instructions, when read by a computer, cause the processor to:
i. provide a method for support vector machine (SVM) tuning using a floating window to transfer data from a training dataset (T) to a validation dataset (V) by interpolation along at least one PAS axis;
ii. determine if both
i. there is a positive correlation coefficient between a drug score and a clinical efficacy of said drug; and
b. an area-under a curve (AUC) statistical indicator for the drug score exceeds 0.7; to provide a predictive indication if said patient is a responder or non-responder to said drug to determine whether said drug should be used in treating said patient.
c. a memory for storing said drug score database (DSD); and
d. a display for displaying data associated with said predictive indication of said patient.

52. A method according to claim 33, wherein said drug, previously used for a first indication, is used for a new second indication and wherein said drug is at least one of repurposed and repositioned.
